(19) United States
(12) Patent Application Publication
(10) Pub. No.: US 2007/0177388 A1
(43) Pub. Date: Aug. 2, 2007

(54) Light-enhancing structure

(76) Inventor: Shih-Yuan Wang, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/655,537

(22) Filed: Jan. 19, 2007

Related U.S. Application Data
(60) Provisional application No. 60/763,581, filed on Jan. 31, 2006.

(51) Int. Cl. F21V 7/00

(52) U.S. Cl. 362/342; 362/341

(57) ABSTRACT

A light-enhancing structure having an optical cavity defined by two Bragg reflectors that are substantially parallel to one another and two edge reflectors that are substantially parallel to one another. A light-emitting material is disposed within the optical cavity. The optical cavity is configured to enhance an incident pump radiation introduced into the optical cavity.

### CROSS-REFERENCE TO RELATED APPLICATION

This application claims the benefit of U.S. Provisional Patent Application Ser. No. 60/763,581, filed Jan. 31, 2006, for LIGHT-ENHANCING STRUCTURE, the disclosure of which is incorporated by reference in its entirety.

### FIELD OF THE INVENTION

The present invention relates to a light-enhancing structure for use in a display device. More specifically, the present invention relates to a light-enhancing structure that has improved performance and has lower power requirements.

### BACKGROUND OF THE INVENTION

Light-emitting diodes (LED) are used in simple displays. An LED is a diode that emits light when current is passed through it. The LED may emit light of a visible or infrared (IR) color depending on the material used as a light-emitting material. Visible LEDs are commonly used as indicator lights in electronic devices while IR LEDs are commonly used in remote control devices. The LED has a p region and an n region that are separated by a junction that provides a barrier to the flow of electrons between the p and n regions. However, when sufficient voltage is applied, the electrons flow from the n region to the p region. After traveling through the light-emitting material, the electrons combine with holes that emit light as they recombine. The light has frequency characteristics that depend on the light-emitting material used in the LED. The color of light emitted by the excited molecules depends on the energy difference between the excited state and the ground state.

In organic LEDs (OLEDs), an organic light-emitting material is placed between two electrodes (an anode and cathode), which are formed on a light-transmissive substrate. OLEDs are commonly used in displays, such as in plasma displays and flat-panel displays. When current is applied across the electrodes, light is emitted from the light-emitting material by electrophosphorescence. An OLED array includes a plurality of organic light-emitting pixels arranged in rows and columns. To generate a full color display, three subpixels are constructed in one pixel, with each subpixel emitting red, green, or blue light. Each subpixel is generally constructed with the two electrodes and the organic light-emitting material deposited between the two electrodes. The color of the subpixel is determined by the electroluminescent medium that is used. The electrodes connect the pixels to form a two-dimensional X-Y addressing pattern. This technology is generally utilized in cathode ray tube (CRT) color displays. Alternatively, a white emitter is used as a backlight in conjunction with a color filter array containing pixels patterned into red, green, and blue subpixels. The technology is widely used in full color liquid crystal displays (LCDs). The color filter-based technology is generally considered less favorable due to the luminescent efficiency limits of most OLED devices and because it uses a source of backlighting.

In the area of display devices, flat panel devices are increasingly replacing CRTs in many computer and television applications. Conventional flat panels, such as LCDs and plasma displays, are becoming cost effective for many applications. At present, LCDs are one of the more popular and mature technologies for low power and cost effective implementations. Unfortunately, conventional LCDs do not have a wide viewing angle. When the viewing angle is shifted from perpendicular to the viewing screen, the light intensity and contrast perceived from the display decreases. As a result, appearance of the image on the LCD changes as the viewing angle changes.

Recently, photoluminescent LCDs (PL-LCDs) have been developed. PL-LCDs use a fluorescent screen, similar to that of a CRT display, to generate color pixels. The colors used to generate the color pixels are formed by photoluminescent compounds or phosphors that generate a specific color wavelength when exposed to an excitation radiation of a specific wavelength. Conventionally, the excitation radiation is ultraviolet light (UV) or deep blue light. An LCD panel modulates which pixels are exposed to the excitation radiation and which pixels are not exposed at any given time. The fluorescent screen eliminates much of the viewing angle problem while still allowing the use of LCD type panels to determine which pixels to excite. Various photoluminescent compounds are known for generating the red, green, or blue wavelengths needed to cover most of the visible light spectrum.

### BRIEF SUMMARY OF THE INVENTION

The present invention relates to a light-enhancing structure having an optical cavity defined by two Bragg reflectors that are substantially parallel to one another and two edge reflectors that are substantially parallel to one another. A light-emitting material is disposed within the optical cavity. The optical cavity is configured to enhance an incident pump radiation introduced into the optical cavity.

The present invention also relates to a display device that includes a plurality of the previously described light-enhancing structures formed on a substrate.

The present invention also relates to a method of enhancing light that includes providing a light-enhancing structure, as described above. An incident pump radiation is enhanced within an optical cavity of the light-enhancing structure. A light-emitting material within the optical cavity is exposed to the enhanced, incident pump radiation, causing light to be emitted from the light-emitting material.

### BRIEF DESCRIPTION OF THE SEVERAL VIEWS OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIGS. 1 and 2 are cross sectional views of one embodiment of an optically pumped, light-enhancing structure; 5

FIGS. 3A and 3B are cross sectional views of particular embodiments of optical modulators;

FIG. 4 is a cross sectional view of an embodiment of an optically pumped, light-enhancing structure;

FIG. 5 is a cross sectional view of an embodiment of an electrically pumped, light-enhancing structure;

FIG. 6 is a cross sectional view of an embodiment of an electrically pumped, light-enhancing structure;

FIG. 7 is a cross sectional view of an embodiment of an optically pumped, light-enhancing structure;

FIGS. 8A and 8B are top views of embodiments of a two-dimensional photonic crystal;

FIG. 9 is a cross sectional view of an embodiment of an optically pumped, light-enhancing structure;

FIG. 10 shows an embodiment of an irradiation array for a display device; and

FIGS. 11A and 11B show particular embodiments of layouts of light-emitting materials used in forming a color pixel for a display device.

### DETAILED DESCRIPTION OF THE INVENTION

In the Detailed Description, various references are made using directional indicators including, but not limited to, top, side, lateral, and adjacent. These directional indicators are used to assist in describing various embodiments of the present invention and do not imply that the present invention is oriented, as described, unless otherwise noted.

Structures or devices that produce enhanced radiation are disclosed. As used herein, the terms “enhance,” “enhanced,” or other forms thereof refer to increasing or making greater, such as increasing the intensity of radiation produced by the structure. The light-enhancing structure may be used in a display device including, but not limited to, a flat panel display or plasma display. For instance, the light-enhancing structure may be used in a screen of a high definition home entertainment system or movie screen. The light-enhancing structure of the present invention may provide improved performance by enclosing a light-emitting material and, optionally, at least one metal structure in an optical cavity. When the light-enhancing structure is exposed to radiation of a selected wavelength, the optical cavity and the metal structure, if present, may enhance the intensity of the radiation. In other words, the optical cavity and the metal structure may concentrate the radiation that develops within the optical cavity. The enhanced radiation may be used to excite the light-emitting material in the optical cavity from a ground state to an excited state. As the excited, light-emitting material decays back to its ground state, light of a desired color may be emitted from the light-enhancing structure. The color of light emitted from the light-enhancing structure may depend on the energy difference between the excited state and the ground state of the light-emitting material. By enhancing the intensity of the radiation within the optical cavity, the light-enhancing structure of the present invention may provide a brighter output compared to that of a conventional OLED. The light-enhancing structure may also have a lower power requirement than a conventional OLED. As such, a low power radiation source may be used to excite the light-emitting material.

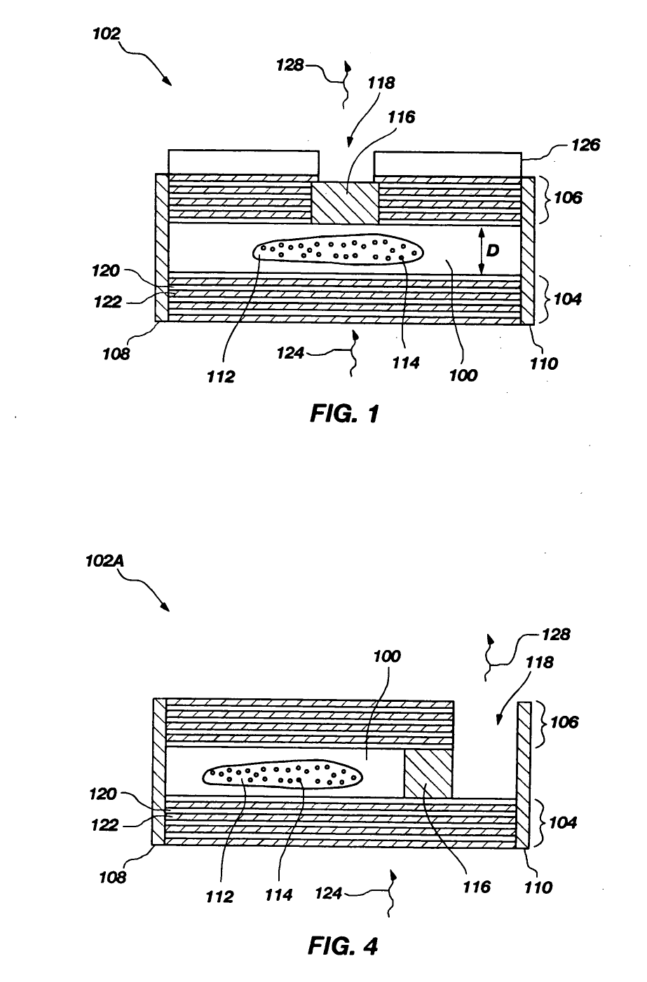

As shown in FIG. 1, the optical cavity 100 of the light-enhancing structure 102 may be defined by two Bragg reflectors 104,106 and two edge reflectors 108,110. The Bragg reflectors 104,106 may provide confinement to the optical cavity 100 in one direction while the edge reflectors 108,110 provide confinement in a second direction. As such, the area between the Bragg reflectors 104,106 and the edge reflectors 108,110 may form the optical cavity 100. The optical cavity 100 may be at least partially filled with the light-emitting material 112. For instance, the light-emitting material 112 may be located at a point of high optical intensity within the optical cavity 100, such as slightly off the point of high optical intensity of the pumping radiation. The light-emitting material 112 may be layered in such a way that each layer is at either the high optical intensity point or just below the high optical intensity point. At least one metal nano-structure 114 may, optionally, be present in the optical cavity 100. As used herein, the term “metal nano-structure” refers collectively to metal nanoparticles, metal nanostructures, or mixtures thereof.

The light-emitting material 112 in the optical cavity 100 may be an organic or an inorganic photoluminescent or fluorescent compound. The light-emitting material 112 may have an excitation wavelength that is visible in the UV range, such as an excitation wavelength that ranges from approximately 100 nm to approximately 500 nm. Light-emitting materials 112 are known in the art and may be used to generate substantially red, substantially green, or substantially blue light after exposure to a selected wavelength of radiation, such as the incident pump radiation 124. The light-emitting material 112 may emit radiation of a wavelength that corresponds to substantially red, substantially green, or substantially blue light as the light-emitting material 112 decays from its excited state to the ground state. To produce red, green, and blue light in a single pixel, each of the red, green, or blue light-emitting materials 112 may be selected to be excited by the same wavelength of radiation. The light-emitting material 112 may be excited by incident pump radiation 124 in the UV radiation spectrum.

For the sake of example only, the light-emitting material 112 may be a conjugated polymer that is luminescent, a hole-transporting polymer doped with electron transport molecules and a luminescent material, an inert polymer doped with hole transporting molecules and a luminescent material, or an amorphous film of luminescent small organic molecules that is doped with other luminescent molecules. The light-emitting material 112 may be formed as a single layer from a single material or may include two or more sublayers formed from the same or different materials. Photoluminescent or fluorescent compounds that may be used as the light-emitting material 112 include, but are not limited to, polyfluorenes, such as 2,7-substituted-9-substituted fluorenes, 9-substituted fluorene oligomers and polymers, and poly(fluorene) copolymers, such as poly(fluorene-co-anthracene)s; polyvinylarylenes, such as poly(p-phenylenevinylene) (PPV), modified PPV in which the phenylene ring is substituted with alkyl, alkoxy, halogen, or nitro groups, modified PPV in which the phenylene ring is replaced with a fused ring system or a substituted fused ring system, such as an anthracene or naphthalene ring system, modified PPV in which the phenylene ring is replaced with a heterocyclic ring system, such as a furan or substituted furan ring, and modified PPV in which the number of vinylene moieties associated with each phenylene or other ring system is increased; anthracene and derivatives thereof; tetracene and derivatives thereof; xanthene and derivatives thereof; perylene and derivatives thereof; rubrene and derivatives thereof; coumarin and derivatives thereof; rhodamine and derivatives thereof; quinacridone and derivatives thereof; distyrylarylene and derivatives thereof; benzazole and derivatives thereof; carbazole and derivatives thereof; dicyanomethylenepyran compounds; thiopyran compounds; polymethine compounds; pyrylium and thiapyrilium compounds; fluorene and derivatives thereof; periflanthene and derivatives thereof; indenoperylene and derivatives thereof; bis(azinyl)amine boron compounds; bis(azinyl)methane compounds; carbostyryl compounds; polysilanes, such as poly(di-n-butylsilane) (PDBS), poly(di-n-pentylsilane) (PDPS), poly(di-n-hexylsilane) (PDHS), poly(methyl-phenylsilane) (PMPS), and poly[-bis(p-butylphenyl)silane] (PBPS); and mixtures thereof.

The light-emitting material 112 may also be an amorphous or crystalline inorganic compound, such as an inorganic phosphorous, indium gallium nitride (InGaN), or gallium phosphite (GaP) compound. However, other inorganic compounds that emit light may also be used.

The optical cavity 100 may optionally include the metal nano-structure 114 to further enhance the incident pump radiation 124 within the optical cavity 100. For instance, if additional output is desired, both the light-emitting material 112 and the metal nano-structure 114 may be enclosed within the optical cavity 100. The metal nano-structure 114 may be formed from silver, gold, copper, aluminum, chromium, platinum, semiconductive materials, or mixtures thereof. The metal nano-structure 114 may include, but is not limited to, at least one metal nanoparticle, at least one metal nanostructure, or mixtures thereof. The metal nanoparticles may have a particle size ranging from approximately 100 nm to approximately 200 nm. The metal nanostructures may be formed into various shapes, such as wires, dots, columns, rods, or pyramids.

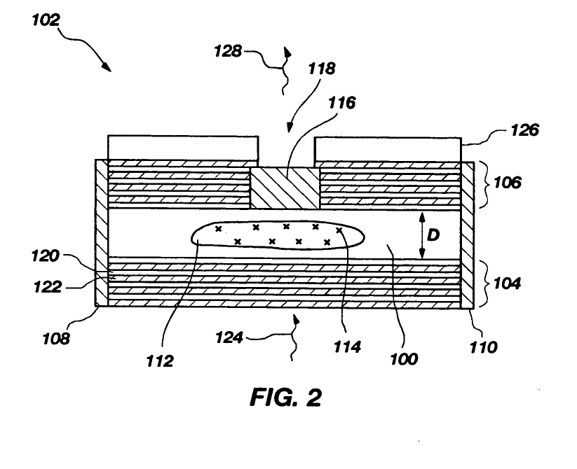

The metal nano-structure 114 may be randomly dispersed in the light-emitting material 112. For instance, particles of the metal nano-structure 114 may be ground and mixed into the light-emitting material 112, resulting in a random distribution of the metal nano-structure 114 within the optical cavity 100, as shown in FIG. 1. Alternatively, the metal nano-structure 114 may be present in a predetermined pattern, as shown in FIG. 2. A pattern of the metal nano-structure 114 may be formed on the light-enhancing structure 102 by patterning the metal of the metal nano-structure 114 onto a substrate. For the sake of example only, the metal nano-structures 114 may be spaced from approximately 1 nm apart to approximately 100 nm apart. The light-emitting material 112 may then be coated over the patterned metal structures 114.

A first Bragg reflector 104 and a second Bragg reflector 106 may be oriented in a substantially parallel plane to one another. Bragg reflectors (also referred to as Bragg mirrors) are one-dimensional photonic crystals, which are three-dimensional structures that exhibit periodicity in refractive index in only one dimension. Alternating layers of low and high refractive index materials create this periodicity in the direction orthogonal to the planes of the alternating layers. Periodicity is not exhibited in either of the two orthogonal dimensions contained within the plane of the layers. Photonic crystals, such as one-dimensional Bragg reflectors, may exhibit a photonic bandgap within a range of certain frequencies in the directions exhibiting periodicity in refractive index. In other words, there is a range of frequencies of radiation or light that is not transmitted through the photonic crystal in the directions exhibiting periodicity in refractive index. The range of frequencies that is not transmitted is known as the photonic bandgap of the photonic crystal.

Each of the first Bragg reflector 104 and the second Bragg reflector 106 may include alternating layers of low and high refractive index materials and may be formed to a thickness of approximately one-fourth the wavelength of the incident pump radiation 124 to be enhanced by the light-enhancing structure 102. For instance, the first Bragg reflector 104 and the second Bragg reflector 106 may be from approximately 10 nm to approximately 100 nm thick. In one embodiment, each of the first Bragg reflector 104 and the second Bragg reflector 106 are formed at a thickness of approximately 25 nm. By way of example, each layer in the first Bragg reflector 104 and the second Bragg reflector 106 may be formed from gallium arsenide (GaAs), aluminum gallium arsenide (AlGaAs), silicon (Si), silicon dioxide (SiO₂), AlGaAs layers having alternating atomic percents of aluminum and gallium, gallium nitride (GaN), aluminum gallium nitride (GaAlN), gallium indium arsenide phosphide (GaInAsP), indium phosphide (InP), magnesium oxide (MgO), hafnium oxide (HfO), calcium fluoride (CaF), silicon nitride (SiN), diamond, or mixtures thereof. In addition, a void (air) may be used as one of the layers in the first Bragg reflector 104 or the second Bragg reflector 106. In photonic crystals, the air or void may constitute the holes in the photonic crystals. Bragg reflectors 104 and 106 may be formed from alternating first layers 120 and second layers 122. For instance, each of the Bragg reflectors may be formed from alternating layers of GaAs and AlGaAs, Si and SiO₂, AlGaAs layers having alternating atomic percents of aluminum and gallium, GaN and GaAlN, or GaInAsP and InP. The first Bragg reflector 104 and the second Bragg reflector 106 may be formed by conventional techniques. Since the first Bragg reflector 104 is transmissive only to certain wavelengths of radiation, the materials used in forming the first Bragg reflector 104 may be selected to be transmissive to radiation of a wavelength that is capable of exciting the light-emitting material 112.

Reflectivity of the Bragg reflectors 104, 106 generally increases with an increasing number of pairs of alternating first layers 120 and second layers 122. The second Bragg reflector 106 may include more pairs of alternating layers 120, 122 than the first Bragg reflector 104, resulting in a higher reflectivity index of the second Bragg reflector 106, which increases the potential optical enhancement within the optical cavity 100. Transmission through the Bragg reflectors 104, 106 may be due to a resonant cavity effect and the higher the number of pairs of alternating first layers 120 and second layers 122, or the greater the reflectivity, the higher the Q of the optical cavity 100 and the narrower the transmission spectrum. A high Q may be desirable for enhancing the optical power density in the optical cavity 100.

The first Bragg reflector 104 and the second Bragg reflector 106 may be separated by a distance D. D may be approximately a one-half standing wave of the pump wavelength. For instance, if the pump wavelength is approximately 250 nm and the optical cavity refractive index is 3, then D may be approximately 40 nm. D may also be multiples of approximately 40 nm, such as 10×40 nm (approximately 400 nm) or greater. A photonic bandgap may exist in directions passing through the planes of the first Bragg reflector 104 and the second Bragg reflector 106. At least one defect mode within the bandgap may be generated as a result of the discontinuity of the periodicity in refractive index generated by the optical cavity 100. The frequency of radiation corresponding to the defect mode may be enhanced within the interior of the optical cavity 100 and may be used to provide enhanced or increased radiation intensity to excite the light-emitting material 112. As explained in more detail below, the optical cavity 100 may be a Fabry-Perot resonant cavity, a cavity formed in a photonic crystal, or a Fabry-Perot resonant cavity in combination with a cavity formed in the photonic crystal.

A first edge reflector 108 and a second edge reflector 110 may be formed at the edges of the optical cavity 100. The first and second edge reflectors 108,110 may be oriented in a substantially parallel plane to one another. The first and second edge reflectors 108,110 may be formed of a material that is substantially reflective to the wavelength of the incident pump radiation 124. For instance, the first and second edge reflectors 108,110 may be photonic crystals. Substantial reflectivity may be achieved by using Distributed Bragg Reflectors (DBR) as the first and second edge reflectors 108,110. Alternatively, the first and second edge reflectors 108,110 may be formed by cleaving the lateral edges of the light-enhancing structure 102, similar to a process for forming a laser diode. Due to these reflective properties, the first and second edge reflectors 108,110 and the first and second Bragg reflectors 104,106 may form a Fabry-Perot resonant cavity (also known as an optical waveguide), which contains and enhances the incident pump radiation 124. The optical cavity 100 may be resonant at a wavelength used to optically or electrically pump the light-emitting material 112.

The light-enhancing structure 102 may be fabricated on a substrate, which provides support. The substrate may be formed from glass, a polymer, silicon, or GaAs. After fabrication of the light-enhancing structure 102, the substrate may be removed if desired. However, if the substrate is optically transparent to the incident pump radiation 124, removal of the substrate may not be needed.

The various layers of the light-enhancing structure 102 may be deposited using conventional techniques including, but not limited to, molecular beam epitaxy (MBE), atomic layer deposition (ALD), chemical vapor deposition (CVD), physical vapor deposition (PVD), sputter deposition, and other conventional microelectronic layer deposition techniques. Photolithography may also be used, such as to form spaces or cavities in the various layers. In addition, nanoimprinting or shadow masking techniques may be used, such as to form the metal structure 114. Nanoimprinting techniques are described in U.S. Pat. No. 6,432,740 to Chen, which is assigned to the assignee of the present invention and is incorporated by reference in its entirety herein. Nanoimprinting provides high throughput at a low cost and causes minimal damage to other components on the light-enhancing structure. Nanoimprinting utilizes compression molding and a pattern transfer process. A mold having nanometer-scale features can be pressed into a thin photoresist cast on a substrate, which creates a thickness contrast pattern in the photoresist. After the mold is removed, a lift-off process or an anisotropic etching process can be used to transfer the pattern into the entire photoresist thickness by removing the remaining photoresist in the compressed areas. Lift-off processes and etching processes are known in the art and, therefore, are not described in detail herein. The material of the metal structure 114 can be deposited in indentations formed by removing the photoresist. The metal material can be deposited by conventional techniques, such as by CVD, PVD, sputtering, or electron beam evaporation.

During fabrication of the light-enhancing structure 102, portions of various layers may also be removed using conventional techniques. Examples of techniques used to selectively remove portions of these layers include, but are not limited to, wet etching, dry etching, plasma etching, and other known microelectronic etching techniques. These techniques for depositing and removing various layers are known in the art and, therefore, are not described in detail herein.

The light-enhancing structure 102 may also include an optical modulator 116 and an exposure region 118 for receiving enhanced radiation from the optical cavity 100. The optical modulator 116 may be disposed in either the first Bragg reflector 104 or in the second Bragg reflector 106. FIG. 1 illustrates the optical modulator 116 disposed in the second Bragg reflector 106. The exposure region 118 may be formed above the optical modulator 116, such as within the second Bragg reflector 106. Alternatively, a confinement layer 126 may be formed on the second Bragg reflector 106 with an opening in the confinement layer 126 to form the exposure region 118. The exposure region 118 may also be formed partially in the second Bragg reflector 106 and partially in the confinement layer 126. The confinement layer 126 may be formed from any suitable material, such as a passivation layer, silicon dioxide, photocurable resin, or thermocurable resin.

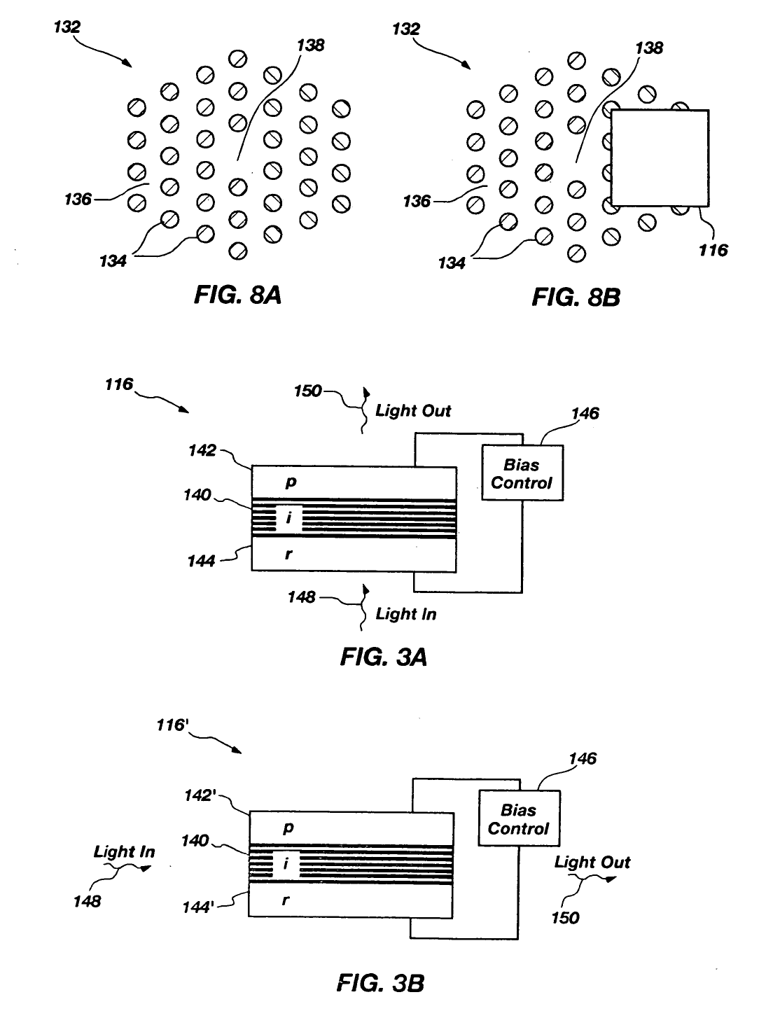

In use and operation, the optical modulator 116 may variably transmit radiation in a direction from the optical cavity 100 to the exposure region 118, generating an excitation radiation 128. In other words, the optical modulator 116 may be used to control the light from the light-emitting material 112 in the optical cavity. Exemplary implementations of optical modulators 116, 116′ are shown in FIGS. 3A and 3B. Generally, an optical modulator 116 may be configured as a quantum well diode. The quantum well diode may be formed as an intrinsic layer 140 sandwiched between a p-type layer 142 and an n-type layer 144, which is conventionally referred to as a PIN diode. A bias control 146 may be used to apply an electrical field between the p-type layer 142 and the n-type layer 144. The intrinsic layer 140 may be composed of a bulk material, such as GaInAsP, or from indium gallium arsenide (InGaAs)/indium gallium aluminum arsenide (InGaAlAs) for a multiple quantum well structure. The intrinsic layer 140 may have an electric-field-dependent absorption coefficient or an electric field dependent refractive index. In bulk intrinsic layers 140, the absorption effect is referred to as the Franz-Keldysh effect, while in quantum well intrinsic layers 140, the absorption effect is referred to as the Stark effect. The refractive index associated with any change in the absorption spectrum of a material is very closely related to the absorption coefficient. This association is often referred to as a Kramer-Kronig relation. By reverse biasing the optical modulator 116, the absorption coefficient of the intrinsic layer 140 may be modified. The amount of energy in the electrical field varies the absorption coefficient such that the intrinsic layer 140 may have a variably transmissive state from substantially non-transmissive to substantially transmissive.

As shown in FIG. 3A, an input beam 148 may impinge on an external surface of the n-type layer 144 and is substantially transmitted to the intrinsic layer 140. Depending on the electrical field applied to the intrinsic layer 140 by the bias control 146, the intrinsic layer 140 transmits a variable portion of the input beam 148 through the p-type layer 142 to an output beam 150. The light direction may also be configured in the opposite direction such that the input beam 148 impinges on the p-type layer 142 and the output beam 150 emanates from the n-type layer 144.

FIG. 3B shows another embodiment of an optical modulator 116′. In this embodiment, the p-type layer 142′ and n-type layer 144′ may be formed as Bragg reflectors, similar to those described above, by doping the materials of the Bragg reflectors with a p-type dopant and an n-type dopant, respectively. The Bragg reflectors form an optical waveguide through the intrinsic layer 140. An input beam 148 directed at a plane substantially parallel to the plane of the PIN diode structure may enter the intrinsic layer 140. Depending on the electrical field applied to the intrinsic layer 140 by the bias control 146, the intrinsic layer 140 transmits a variable portion of the input beam 148 to an output beam 150 emanating from the opposite end of the intrinsic layer 140.

Either embodiment of the optical modulator (116 or 116′) may be used in the light-enhancing structure 102. However, since the radiation travels in a direction perpendicular to the first and second Bragg reflectors 104,106, it may be easier to implement the optical modulator 116 embodiment of FIG. 3A because the layers of the PIN diode lie in the same plane as the first and second Bragg reflectors 104,106, which may make fabrication easier.

The optical cavity 100, in combination with the optional metal structure 114, may increase the intensity of radiation to which the light-emitting material 112 is exposed. Since the first Bragg reflector 104 is selectively transmissive, the optical cavity 100 may enhance radiation of only specific wavelengths, which are at least partly determined by the physical dimensions of the optical cavity 100. The enhanced radiation within the optical cavity 100 may then excite the light-emitting material 112. As the excited, light-emitting material 112 decays to its ground state, the light-enhancing structure 102 may emit light, producing the desired red, green, or blue color of the light-enhancing structure 102. Since the optical cavity 100 and the metal structure 114 enhance the radiation within the optical cavity 100, the light-enhancing structure 102 may have an increased output based on a given amount of power provided by the incident pump radiation 124. Alternatively, if the light-enhancing structure 102 is to be used in a situation where increased output is not desired, a lower amount of power may be provided by the incident pump radiation 124 to produce the desired output. As such, the light-enhancing structure 102 may produce the desired output while having lower power requirements.

To produce light with the light-enhancing structure 102, the incident pump radiation 124 may be directed at the first Bragg reflector 104. The incident pump radiation 124 may be UV radiation, which has a wavelength ranging from approximately 100 nm to approximately 380 nm. For example, in one embodiment, the incident pump radiation 124 is approximately 300 nm. A source of the incident pump radiation 124 may be a UV light-emitting diode or other source that provides the desired wavelength of radiation. At least a portion of the incident pump radiation 124 may be transmitted through the first Bragg reflector 104 and into the optical cavity 100. If the optical modulator 116 is configured to be substantially nontransmissive, the incident pump radiation 124 may be enhanced within the optical cavity 100 because very little radiation is capable of escaping from the optical cavity 100 due to the reflective properties of the first and second Bragg reflectors 104,106 and the first and second edge reflectors 108,110. The optical modulator 116 may be used to control the light from the light-emitting material 112 in the optical cavity 100. The difference in refractive index at interfaces between the first Bragg reflector 104 and the optical cavity 100, and between the second Bragg reflector 106 and the optical cavity 100, may cause at least some of the incident pump radiation 124 to be reflected internally within the optical cavity 100, rather than being transmitted through either of the first and second Bragg reflectors 104,106.

When the distance D separating the first Bragg reflector 104 and the second Bragg reflector 106 is equal to an integer number of half wavelengths of the incident pump radiation 124, the enhanced radiation may interfere constructively, causing the intensity and power of the radiation inside the optical cavity 100 to increase. As a result, the distance D between the first Bragg reflector 104 and the second Bragg reflector 106 may be selected based upon the wavelength of the incident pump radiation 124 that is used to excite the light-emitting material 112. For example, if the incident pump radiation 124 is to have a wavelength of 100 nm, the distance D may be an integer multiple of 50 nm. Therefore, D may be 50 nm, 100 nm, 150 nm, 200 nm, etc. assuming that the cavity refractive index is 1.

When the condition for resonance within the optical cavity 100 is satisfied, the intensity of the incident pump radiation 124 within the optical cavity 100 may be increased by a factor of approximately 1000 or greater. Since the incident pump radiation 124 is enhanced by the optical cavity 100, the incident pump radiation 124 may be of a relatively low intensity. For instance, if the power of the incident pump radiation 124 is 1 mW, the power of the radiation resonating within the optical cavity 100 may be approximately 1 W. Since the intensity of the radiation inside the optical cavity 100 may be very high, non-linear effects, such as second harmonic generation, may be appreciable, resulting in increased performance of the light-enhancing structure 100.

Upon contacting the light-emitting material 112, the enhanced, incident pump radiation may excite the light-emitting material 112 from its ground state to its excited state. The optical modulator 116 may be configured in a variably transmissive state, allowing some of the enhanced, incident pump radiation to be transmitted to the exposure region 118 as excitation radiation 128. The wavelength of the excitation radiation 128 emitted from the light-enhancing structure 102 may provide the desired color of the light-enhancing structure 100. The light-enhancing structure 102 of the present invention may emit red, green, or blue light depending on the material used as the light-emitting material 112 and the wavelength of the incident pump radiation 124.

FIG. 4 illustrates an alternate embodiment of a light-enhancing structure 102A, which is similar to the light-enhancing structure 102 of FIG. 1. However, in the embodiment of FIG. 4, the optical modulator 116 is disposed in the optical cavity 100 between the first Bragg reflector 104 and the second Bragg reflector 106. Additionally, the exposure region 118 is shown disposed laterally adjacent the optical modulator 116, such that the enhanced radiation may be variably transmitted through the optical modulator 116 from the optical cavity 100 to the exposure region 118. The exposure region 118 may extend through at least a portion of the optical cavity 100 and the first Bragg reflector 104. As with the embodiment shown in FIG. 1, the exposure region 118 may be formed through the first Bragg reflector 104 or the second Bragg reflector 106, depending on the desired orientation.

Operation of the light-enhancing structure 102A may be similar to that of the light-enhancing structure 102. However, in the light-enhancing structure 102A, the optical modulator 116 is disposed in the optical cavity 100 between the first Bragg reflector 104 and the second Bragg reflector 106. As with the embodiment of FIG. 1, either embodiment of the optical modulator (116 or 116′) may be used in the light-enhancing structure 102A. However, since the radiation travels in a direction parallel to the layers of the first and second Bragg reflectors 104,106, it may be easier to implement the optical modulator 116′ because the layers forming the PIN diode lie in the same plane as the layers of the first and second Bragg reflectors 104, 106, which may make fabrication easier.

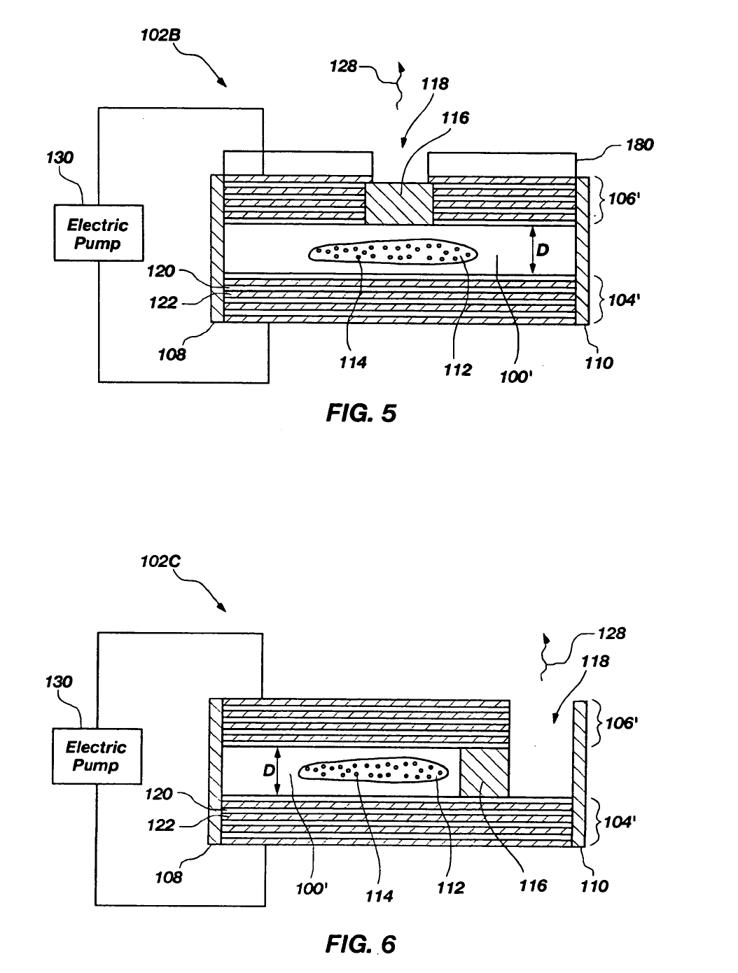

The light-emitting material 112 in the light-enhancing structures 102, 102A may be excited optically, such as by using an optical pump. However, electrical pumping is also contemplated, such as by using an electron beam. Light-enhancing structures 102B, 102C having electrical pumps are shown in FIGS. 5 and 6. FIG. 5 illustrates an embodiment of the light-enhancing structure 102B, which functions in a similar manner to the light-enhancing structure 102. However, in the light-enhancing structure 102B, the first Bragg reflector 104′ is a p-doped material and the second Bragg reflector 106′ is an n-doped material. When configured with an electrical pump 130, the first Bragg reflector 104′, the second Bragg reflector 106′, and the optical cavity 100′ may generate a desired wavelength of light, similar to an edge emitting laser diode. The doping and polarity of the electrical pump 130 may also be reversed, such that the first Bragg reflector 104′ is an n-doped material and the second Bragg reflector 106′ is a p-doped material. As in the light-enhancing structure 102, the optical modulator 116 in the light-enhancing structure 102B may be disposed in either the first Bragg reflector 104′ or in the second Bragg reflector 106′. FIG. 5 illustrates an embodiment where the optical modulator 116 is disposed in the second Bragg reflector 106′. In addition, an exposure region 118 may be formed above the optical modulator 116.

FIG. 6 illustrates an embodiment of a light-enhancing structure 102C that is similar to the embodiment of FIG. 4. However, in the light-enhancing structure 102C, the first Bragg reflector 104′ is a p-doped material and the second Bragg reflector 106′ is an n-doped material. When configured with an electrical pump 130, the first and second Bragg reflectors 104′,106′ and the optical cavity 100′ may generate a desired wavelength of light, similar to an edge emitting laser diode. The doping and polarity of the electrical pump 130 may also be reversed, such that the first Bragg reflector 104′ is an n-doped material and the second Bragg reflector 106′ is a p-doped material. As with the light-enhancing structure 102A, the optical modulator 116 of light-enhancing structure 102C may be disposed in the optical cavity 100′ between the first Bragg reflector 104′ and the second Bragg reflector 106′. Additionally, the exposure region 118 may be disposed laterally adjacent to the optical modulator 116 such that the enhanced radiation may be variably transmitted through the optical modulator 116 from the optical cavity 100′ to the exposure region 118.

The defect or discontinuity in the periodicity in refractive index, which results in amplification of the incident pump radiation 124 in the optical cavity 100, may also be caused by a cavity formed in a photonic crystal or by a Fabry-Perot resonant cavity in combination with a cavity formed in the photonic crystal. When the periodicity in refractive index in the photonic crystal is interrupted, such as by a defect or a missing layer in a Bragg mirror, defect modes may be generated. The defect may be generated within the photonic crystal by, for example, changing the refractive index within the photonic crystal at a specific location, changing the size of a feature in the photonic crystal, or by removing one feature from a periodic array within the photonic crystal. These defect modes allow certain frequencies of light within the bandgap to be partially transmitted through the photonic crystal and enter into the defect area where the incident pump radiation 124 is at least partially trapped or confined. As more incident pump radiation 124 enters the defect area and becomes trapped or confined, the intensity of the incident pump radiation 124 may be increased within the optical cavity 100, providing a similar intensity enhancing effect as produced by a Fabry-Perot resonant cavity. The frequencies associated with the defect modes are, at least partially, a function of the dimensions of the defect. The finite-difference time-domain method may be used to solve the full-vector time-dependent Maxwell's equations on a computational grid including the macroscopic dielectric function, which will be at least partially a function of the feature dimensions and corresponding dielectric constant within those features, of the photonic crystal to determine which wavelengths may be forbidden to exist within the interior of any given crystal and which wavelengths will give rise to a defect mode at the location of a defect within the crystal.

As illustrated in FIG. 7, the optical cavity 100 of the light-enhancing structure 102D may include a two-dimensional photonic crystal material 132. The two-dimensional photonic crystal material 132 may be formed by periodically dispersing columns 134 within a matrix 136. The columns 134 may be formed from a material of one refractive index while the matrix 136 may be formed from a material having a different refractive index. Examples of materials used for the columns 134 and the matrix 136 include, but are not limited to, GaAs and AlGaAs, AlGaAs columns within an AlGaAs matrix having different atomic percents of Al and Ga, GaN and GaAlN, Si and SiO₂, Si and SiN, and GaInAsP and InP. In practice, virtually any two materials that have different refractive indices may be used for the columns 134 and the matrix 136. The two-dimensional photonic crystal material 132 exhibits periodicity in only two dimensions (i.e., the directions perpendicular to the length of the columns 134), but no periodicity is exhibited in the direction parallel to the length of the columns 134. The periodicity of the two-dimensional photonic crystal material 132 and the first and second Bragg reflectors 104 and 106 may be selected to reflect the wavelength of the incident pump radiation 124.

The defect 138 in the two-dimensional photonic crystal material 132 may be caused by changing the refractive index within the two-dimensional photonic crystal material 132 at a specific location, by changing the size of one of the columns 134 in the two-dimensional photonic crystal material 132, or by removing one of the columns 134 from the periodic array within the two-dimensional photonic crystal material 132. For instance, one column 134 in the center of the optical cavity 100 may be missing, creating defect 138. Alternatively, the defect 138 may be formed by providing a column having a diameter greater than or less than the diameter of the columns 134 or by providing an air gap or a spatially confined area of a different material, such as glass or epoxy.

The two-dimensional photonic crystal material 132 having defect 138, as shown in a top view in FIGS. 8A and 8B, may create a highly refractive behavior in the periodicity of the two-dimensional photonic crystal material 132. The defect 138 may create a high-Q cavity at the site of the defect 138 due to the high reflectivity in the plane perpendicular to the columns 134. The high-Q cavity is defined by the high reflectivity of the first and second Bragg reflectors 104,106 on either side of the two-dimensional photonic crystal material 132. The light-enhancing structure 102D having the defect 138 (high-Q cavity) may exhibit enhanced amplification of the incident pump radiation 124 compared to the light-enhancing structures 102-102C (illustrated in FIGS. 1 and 4-6) due to the small confinement region within the defect 138. In addition, the enhanced incident pump radiation 124 within the defect 138 may not propagate laterally to escape from the defect 138.

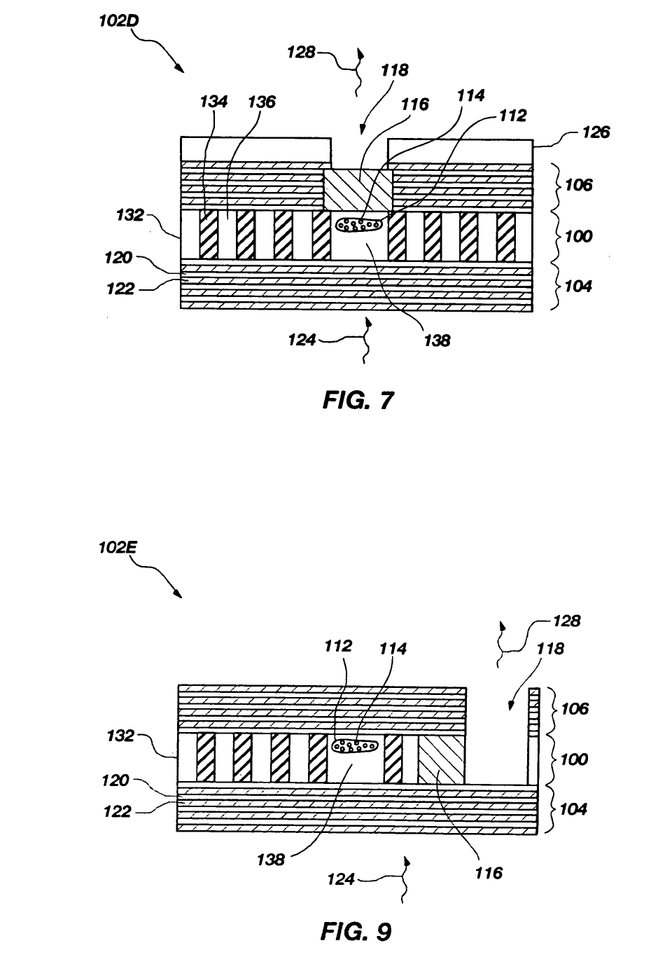

FIG. 9 illustrates another embodiment of a light-enhancing structure 102E, which is similar to the light-enhancing structure 102D. However, in light-enhancing structure 102E, the optical modulator 116 may be disposed in the two-dimensional photonic crystal material substantially near the defect 138 (high-Q cavity) and between the first and second Bragg reflectors 104,106. The exposure region 118 may be disposed laterally adjacent the optical modulator 116 such that the enhanced incident pump radiation 124 may be variably transmitted through the optical modulator 116 from the defect 138 to the exposure region 118. The exposure region 118 may extend through at least a portion of the two-dimensional photonic crystal material 132 and the second Bragg reflector 106. As in light-enhancing structure 102, the exposure region 118 in light-enhancing structure 102E may be formed in the first Bragg reflector 104 or in the second Bragg reflector 106, depending on the desired orientation.

The light-enhancing structures 102A-102E (illustrated in FIGS. 4-7 and 9) operate in a similar fashion to light-enhancing structure 102 and may enhance the incident pump radiation 124 in one of two ways. For example, the light-enhancing structures 102-102C (illustrated in FIGS. 1 and 4-6) may operate as a Fabry-Perot resonating cavity when the wavelength of the incident pump radiation 124 is an integer multiple of one half of the distance separating the first and second Bragg reflectors 104,106, as discussed previously. In light-enhancing structures 102D, 102E (illustrated in FIGS. 7 and 9), the incident pump radiation 124 may be enhanced when the wavelength of the incident pump radiation 124 corresponds to a defect mode generated by the resonant cavity between the Bragg mirrors, which creates a discontinuity in the periodicity in refractive index of the one dimensional photonic crystal Bragg mirrors.

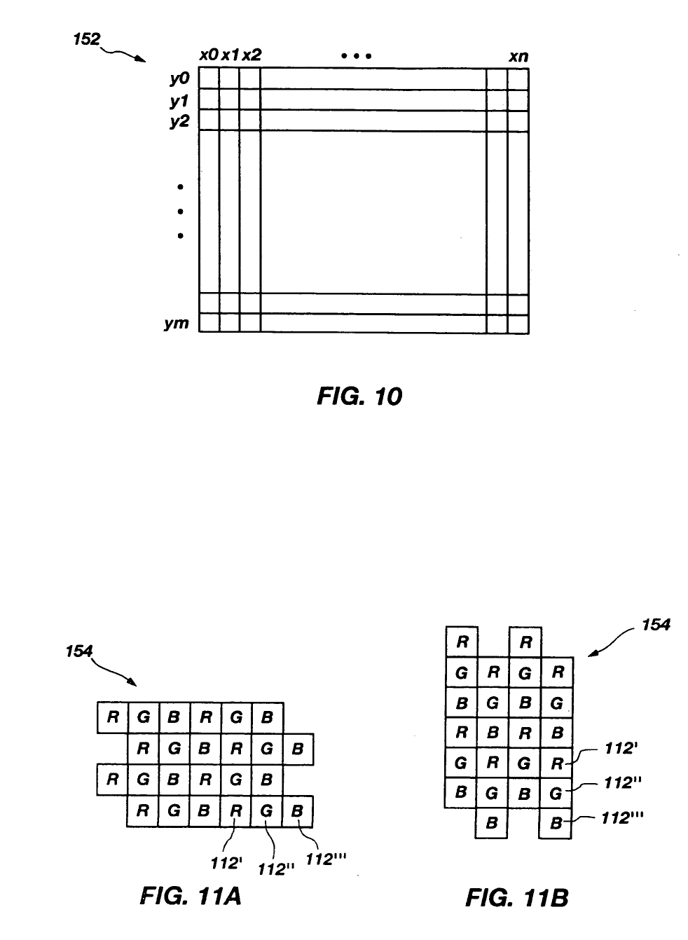

A plurality of light-enhancing structures 102 may be formed on the substrate in an irradiation array 152 to form a display device, as illustrated in FIG. 10. In addition to light-enhancing structure 102, other light-enhancing structures, such as light-enhancing structures 102A-102E, or combinations of any of light-enhancing structures 102-102E, may be used in the irradiation array 152. FIG. 10 shows one possible rectilinear arrangement of the light-enhancing structures 102 where the number of light-enhancing structures in the x direction (i.e., x0 to xn) and the number of light-enhancing structures in the y direction (i.e., y0 to ym) may be a variety of values depending on the size of the irradiation array 152 and the application of the irradiation array 152. When the irradiation array 152 is used as a display device, each light-enhancing structure may be considered a display pixel 154. The display device may be configured to be monochromatic in that all of the display pixels 154 may be configured to emit the same color of light. In the monochromatic display, the light-emitting material 112 used in each light-enhancing structure may be of the same type and, therefore, may emit the same color of light. For the sake of example only, to create a display device that emits green light, the light-emitting material 112 may be a photoluminescent compound that emits substantially green light when excited by incident pump radiation 124. Similarly, to produce a display device that emits red light or blue light, respectively, the light-emitting material 112 may be a photoluminescent compound that emits substantially red light or substantially blue light, respectively, when excited by incident pump radiation 124.

The irradiation array 152 may also be configured as a full color display capable of generating substantially the full visible light spectrum. In this situation, each display pixel 154 has multiple light-enhancing structures, such as any of light-enhancing structures 102-102E, that include a substantially red emitting light-emitting material 112′, a substantially green emitting light-emitting material 112″, and a substantially blue emitting light-emitting material 112′″.

Exemplary spatial configurations of the display pixels 154 are shown in FIGS. 11A and 11B. FIG. 11A shows a display pixel arrangement where each display pixel 154 is aligned horizontally. The display pixel 154 includes a row of red (R) light-emitting materials 112′, a row of green (G) light-emitting materials 112″, and a row of blue (B) light-emitting materials 112′″. Conventionally, the next row of display pixels 154 may have the red, green, and blue light-emitting materials 112′, 112″, and 112′″ staggered to reduce the formation of vertical color lines. FIG. 11B shows a display pixel arrangement where each display pixel 154 is aligned vertically. In other words, the display pixel 154 includes a column of the red light-emitting material 112′, the green light-emitting material 112″, and the blue light-emitting material 112′″. Conventionally, the next column of display pixels 154 may have the red, green, and blue portions staggered to reduce the formation of horizontal color lines. While the red, green, and blue portions of the display pixel 154 are shown as square in FIGS. 11A and 11B, they may be formed in a substantially rectangular shape so that the overall display pixel 154 (formed from the red, green, and blue portions) is substantially square. While FIGS. 11A and 11B show examples of configurations of the display pixels 154, additional configurations that are within the scope of the present invention may be contemplated.

Since a single display pixel 154 may include red, green, and blue subpixels, each having individual or collective optical cavities 100 that are individually or collectively excited by the incident pump radiation 124, the desired color emitted by the display pixel 154 may be controlled by gating of the subpixels. For instance, the subpixels may be controlled electrically or by liquid crystal light valves. To obtain the desired color of the display pixel 154, the red, green, and blue subpixels may be formed in parallel, as known in the art, with each of the red, green, and blue subpixels formed separately. A gate, such as a liquid crystal gate, may be used to selectively allow a particular wavelength of radiation to enter or exit the optical cavity 100, enabling the desired color to be produced. The red, green, and blue subpixels may also be formed in series, as known in the art, by placing the individual red, green, and blue subpixels on top of one another. In the series embodiment, one of the red, green, or blue subpixels is excited using a gate in combination with a filter. To achieve the desired color or a desired mixture of colors, the filter may be activated at the same time as the light-emitting material 112 is exposed to the incident pump radiation 124.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A light-enhancing structure, comprising:
an optical cavity defined by two Bragg reflectors that are substantially parallel to one another and two edge reflectors that are substantially parallel to one another; and
a light-emitting material disposed within the optical cavity,
wherein the optical cavity is configured to enhance an incident pump radiation introduced into the optical cavity.

2. The light-enhancing structure of claim 1, wherein the light-emitting material is selected to emit radiation of a red, green, or blue color after exposure to the enhanced incident pump radiation.

3. The light-enhancing structure of claim 1, wherein the light-emitting material at least partially fills the optical cavity.

4. The light-enhancing structure of claim 1, wherein the light-emitting material in the optical cavity is optically pumped by the incident pump radiation transmitted through a first Bragg reflector of the two Bragg reflectors.

5. The light-enhancing structure of claim 4, wherein the incident pump radiation comprises ultraviolet radiation.

6. The light-enhancing structure of claim 1, wherein the light-emitting material in the optical cavity is electrically pumped by the incident pump radiation transmitted through a first Bragg reflector of the two Bragg reflectors.

7. The light-enhancing structure of claim 6, wherein the incident pump radiation comprises an electron beam.

8. The light-enhancing structure of claim 1, wherein the optical cavity comprises at least one defect therein.

9. The light-enhancing structure of claim 8, wherein the at least one defect provides a discontinuity in periodicity in refractive index in a direction perpendicular to a plane of the two Bragg reflectors.

10. The light-enhancing structure of claim 1, further comprising at least one metal structure dispersed in the optical cavity.

11. The light-enhancing structure of claim 10, wherein the at least one metal structure comprises at least one metal nanoparticle, at least one metal nanostructure, or mixtures thereof.

12. The light-enhancing structure of claim 10, wherein the at least one metal structure is randomly dispersed in the light-emitting material.

13. The light-enhancing structure of claim 10, wherein the at least one metal structure is patterned within the optical cavity.

14. A display device comprising a plurality of light-enhancing structures formed on a substrate, wherein each of the plurality of light-enhancing structures comprises:
an optical cavity defined by two Bragg reflectors that are substantially parallel to one another and two edge reflectors that are substantially parallel to one another; and
a light-emitting material disposed within the optical cavity,
wherein the optical cavity is configured to enhance an incident pump radiation introduced into the optical cavity.

15. The display device of claim 14, wherein the light-emitting material at least partially fills the optical cavity.

16. The display device of claim 14, wherein the light-emitting material in the optical cavity is optically pumped.

17. The display device of claim 14, wherein the light-emitting material in the optical cavity is electrically pumped by the incident pump radiation.

18. The display device of claim 14, wherein the optical cavity comprises at least one defect therein.

19. A method of enhancing light, comprising:
providing a light-enhancing structure comprising:
an optical cavity defined by two Bragg reflectors that are substantially parallel to one another and two edge reflectors that are substantially parallel to one another; and
a light-emitting material disposed within the optical cavity;
enhancing an incident pump radiation within the optical cavity;
exposing the light-emitting material to the enhanced, incident pump radiation; and
emitting light from the light-emitting material.

20. The method of claim 19, wherein providing a light-enhancing structure comprises providing an optical cavity having at least one defect therein.

21. The method of claim 20, wherein providing an optical cavity comprising at least one defect therein comprises providing at least one defect in the optical cavity that provides a discontinuity in periodicity in refractive index in a direction perpendicular to a plane of the two Bragg reflectors.

22. The method of claim 19, wherein providing a light-enhancing structure comprises providing a light-enhancing structure that further comprises at least one metal structure dispersed in the optical cavity.

23. The method of claim 22, wherein providing a light-enhancing structure that further comprises at least one metal structure dispersed in the optical cavity comprises providing at least one metal structure that comprises at least one metal nanoparticle, at least one metal nanostructure, or mixtures thereof dispersed in the optical cavity.

24. The method of claim 19, wherein enhancing an incident pump radiation within the optical cavity comprises introducing ultraviolet radiation or an electron beam into the optical cavity.

25. The method of claim 19, wherein enhancing an incident pump radiation within the optical cavity comprises transmitting the incident pump radiation through a first Bragg reflector of the two Bragg reflectors and providing a second Bragg reflector of the two Bragg reflectors that is nontransmissive to the incident pump radiation.

26. The method of claim 19, wherein exposing the light-emitting material to the enhanced, incident pump radiation comprises exciting the light-emitting material from a ground state to an excited state.

27. The method of claim 19, wherein emitting light from the light-emitting material comprises emitting red, green, or blue light from the light-enhancing structure.
